(19) United States
(12) Patent Application Publication
(10) Pub. No.: US 2026/0170309 A1
(43) Pub. Date: Jun. 18, 2026

(54) USING A GENERATIVE MODEL TO CONVERT DATA PROCESSES OF A COMPUTER SYSTEM INTO WORKFLOW CODE

(71) Applicant: Maplebear Inc., San Francisco, CA (US)

(72) Inventor: Anant Agarwal, Santa Clara, CA (US)

(21) Appl. No.: 18/986,419

(22) Filed: Dec. 18, 2024

(51) Int. Cl. G06N 3/0475; G06F 9/50; G06N 3/096

(52) U.S. Cl. CPC G06N 3/0475; G06F 9/505; G06N 3/096

(57) ABSTRACT

A computer system uses a generative model to convert data processes of the computer system into workflows. The computer system receives, via a user interface, input data including a definition of a workflow that represents a set of one or more operations performed on data stored in a database of the computer system, and a request for generating the workflow. The computer system generates a prompt for input into the language model, the prompt including the definition of the workflow and the request for generating the workflow. The computer system requests the generative model to generate, based on the prompt input into the generative model, a response that includes a workflow code for executing the workflow. The computer system executes the workflow by deploying the workflow code.

### BACKGROUND

Computer systems that access large databases (e.g., online systems) may have workflow creation tools that enable users to generate data workflows that operate on a specific set of data stored in a database. These tools run code that converts information from an input form populated manually by a user into a data workflow. However, these tools require a user of the computer system to make a lot of decisions about how the workflow is created to populate the form, which is inherently ineffective and prone to errors. It is therefore desirable to avoid requiring a user to make decisions when creating data workflows.

### SUMMARY

Embodiments of the present disclosure are directed to using a generative model to automatically convert data processes of a computer system into a workflow code, i.e., the code that runs a workflow of data.

In accordance with one or more aspects of the disclosure, the computer system receives, via a user interface of the computer system, input data including a definition of a workflow that represents a set of one or more operations performed on data stored in a database of the computer system. The computer system receives, via the user interface, a request for generating the workflow. The computer system generates a prompt for input into a generative model, the prompt including the definition of the workflow and the request for generating the workflow. The computer system requests the generative model to generate, based on the prompt input into the generative model, a response that includes a workflow code for executing the workflow. The computer system executes the workflow by deploying the workflow code.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3 illustrates an example architectural flow diagram of using a generative model (e.g., language model) to convert data processes of a computer system (e.g., online system) into workflows, in accordance with one or more embodiments.

FIG. 4 is a flowchart for a method of using a generative model (e.g., language model) to convert data processes of a computer system (e.g., online system) into workflows, in accordance with one or more embodiments.

### DETAILED DESCRIPTION

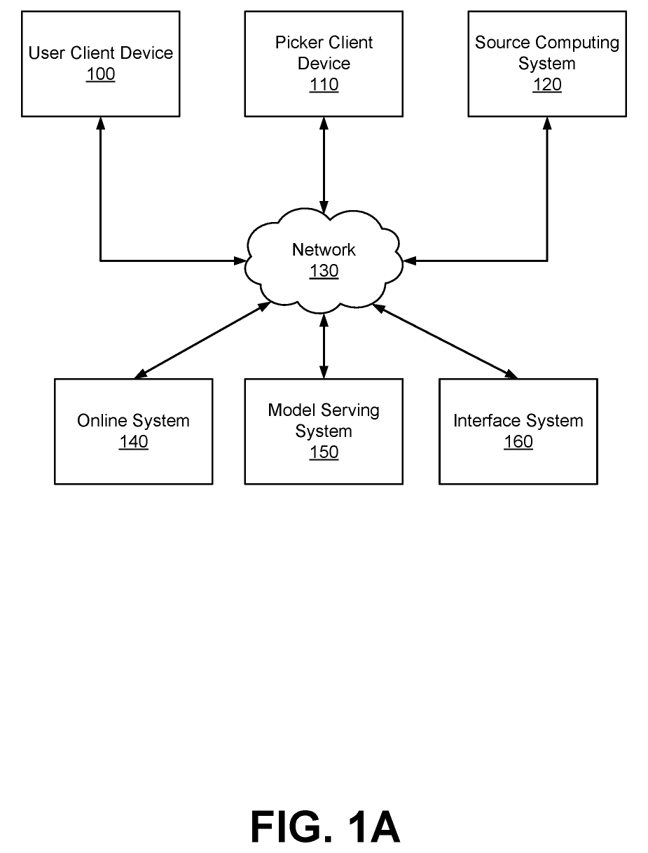

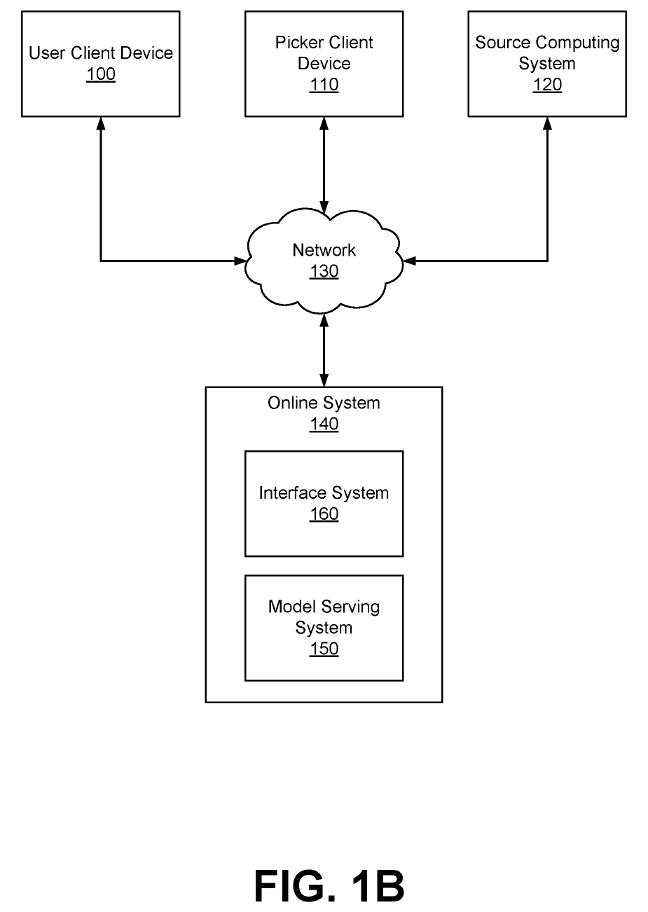

FIG. 1A illustrates an example system environment for an online system 140, in accordance with one or more embodiments. The system environment illustrated in FIG. 1A includes a user client device 100, a picker client device 110, a source computing system 120, a network 130, an online system 140, a model serving system 150, and an interface system 160. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1A, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” An “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user’s order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the user’s order to the picker in a collection interface. The collection interface is a user interface that provides information to the picker on which items to collect for a user’s order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user’s order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker’s location. For example, if the picker takes a wrong turn while traveling to a delivery location, the online system 140 determines the picker’s updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system 140 and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. Patent Application No. 18/630,672, entitled “Automated Identification of Items Placed in a Cart and Recommendations based on Same,” filed April 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user’s order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user’s order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

As an example, the online system 140 may allow a user to order groceries from a grocery store source. The user’s order may specify which groceries they want to be delivered from the grocery store and the quantities of each of the groceries. The user client device 100 transmits the user’s order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140.

The online system 140 (i.e., computing system) provides a workflow creation tool for generating workflows that operate on a specific database technology. A workflow may represent an operation or a set of operations performed on data stored in a database of the online system 140. To minimize the information needed by a user who is creating a new workflow, the online system 140 uses a generative model (e.g., language model, such as an LLM of the model serving system 150) to make decisions for generating the new workflow and schedules the workflow based on system usage data. When generating a new workflow, the online system 140 receives a definition of the workflow to be created. The online system 140 then generates a prompt for input into the generative model with a request to generate the desired workflow, where the generative model is tuned with previously created workflows and system usage metrics. An output from the generative model includes a code for implementing the workflow, which may be reviewed by a human. Once approved, the code is deployed according to a schedule, which may also be suggested by the generative model.

The online system 140 presented herein may generate programmatic and automated workflows for data infrastructure processes where a user simply interacts with the generative model (e.g., by providing information using an input form), and the generative model returns a set of pipelines, configurations, queries etc. that are then executed to perform a corresponding data infrastructure process. The online system 140 leverages the generative model and a user interface to enable the creation and automation of complex workflows that span multiple technologies and processes.

The problem being addressed herein is the difficulty in stitching together disparate systems and actions into cohesive, end-to-end workflows, especially for non-technical users or those unfamiliar with the underlying technologies. The approach presented herein solves the problem by allowing users to define their desired workflows through a user-friendly interface, providing prompts or forms to the generative model to capture the necessary inputs. These inputs may be then processed by the generative model, which generates the code or instructions required to orchestrate the various components and execute the desired actions across the different systems that are being involved.

By applying the approach presented herein, the online system 140 can streamline the creation and management of complex data pipelines, infrastructure provisioning, and other processes that involve multiple tools and services. The online system 140 may empower users to define their requirements without needing extensive technical knowledge, while leveraging existing infrastructure of the online system 140 and best practices encoded within the generative model. The advantage of utilizing the generative model is that the user is not required to fill long user interface forms that are convoluted with multiple different processes. Moreover, the entire system can be simplified with application programming interfaces (APIs) using the generative model and the backend APIs. Furthermore, the online system 140 leverages the generative model to intelligently schedule and optimize the execution of data pipelines, data quality checks, indexing jobs, and other data-related processes across various database technologies.

The additional problem being addressed herein is the complexity of scheduling and orchestrating multiple data processes across different technologies while considering factors such as resource utilization, peak demand times, and business-specific requirements. Traditionally, this scheduling process is often manual, error-prone, and requires extensive domain knowledge and experimentation. By employing the generative model, the online system 140 aims to automate and optimize the scheduling process, taking into account relevant inputs and constraints. The generative model can analyze historical data, resource usage patterns, business cycles, and user requirements to generate optimized schedules for running data processes. The approach presented herein solves the problem within the environment of the online system 140 by ensuring efficient resource utilization, minimizing queue times, and aligning data processing with business demands, ultimately improving the overall performance and reliability of data infrastructure of the online system 140.

The model serving system 150 receives requests from the online system 140 to perform tasks using machine-learning models. The tasks include, but are not limited to, natural language processing (NLP) tasks, audio processing tasks, image processing tasks, video processing tasks, and the like. In one or more embodiments, the machine-learning models deployed by the model serving system 150 are language models configured to perform one or more NLP tasks. The NLP tasks include, but are not limited to, text generation, query processing, machine translation, chatbots, and the like. In one or more embodiments, a language model of the model serving system 150 is configured as a transformer neural network architecture (i.e., a transformer model). Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learning model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learning model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 140 or one or more entities different from the online system 140. An LLM may be trained on a large amount of data from various data sources. For example, the data sources include websites, articles, posts on the web, and the like. From this massive amount of data coupled with the computing power of LLM, the LLM is able to perform various tasks and synthesize and formulate output responses based on information extracted from the training data.

In one or more embodiments, when the machine-learning model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In one or more other embodiments, the transformer architecture may have an encoder-decoder architecture and includes a set of encoders coupled to a set of decoders. An encoder or decoder may include one or more attention operations.

While a LLM with a transformer-based architecture is described in one or more embodiments, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

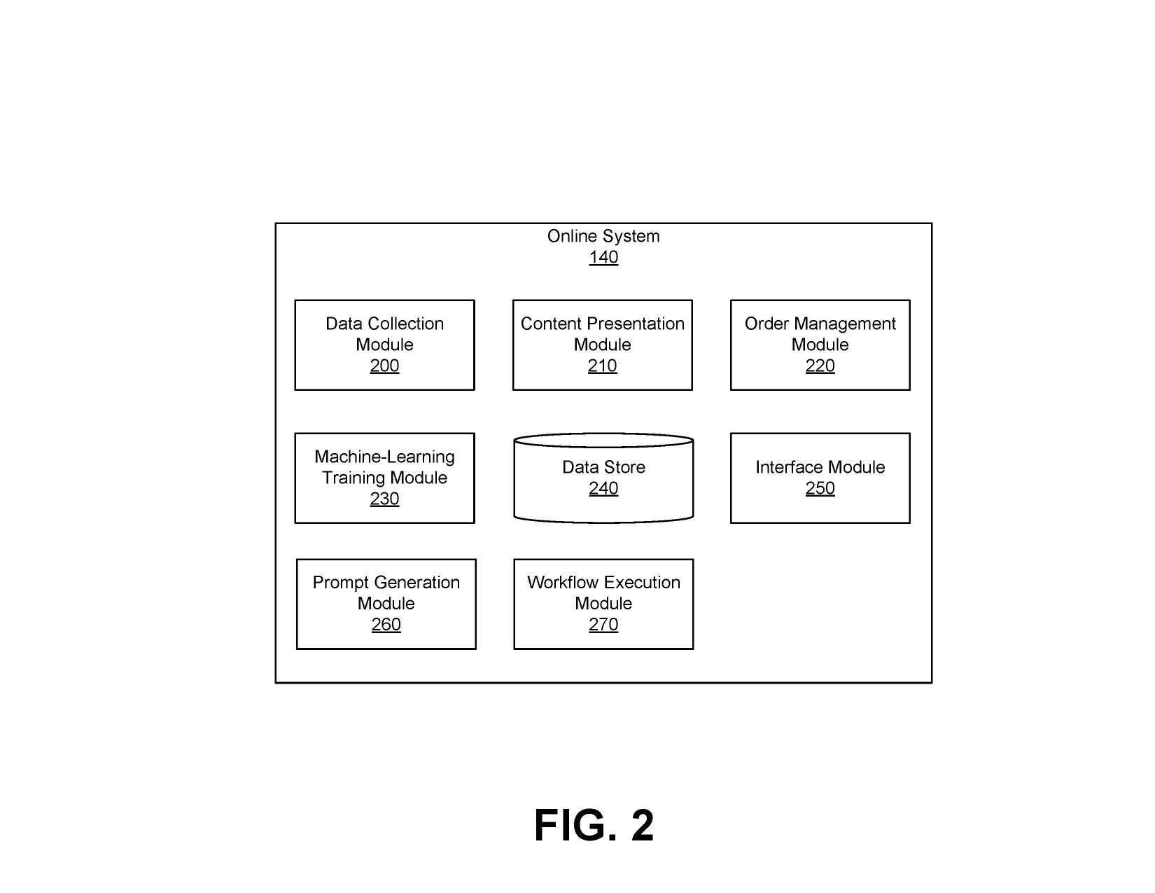

The online system 140 may use an LLM (e.g., LLM of the model serving system 150) to make the decisions needed to generate a workflow. Furthermore, the online system 140 may utilize the LLM to generate scheduling of when to perform the workflow, e.g., to balance the use of the computing resources at the online system 140. The online system 140 generates (e.g., via a prompt generation module 260 in FIG. 2) a prompt for input into the LLM. The prompt may include past workflows, usage metrics (e.g., for load balancing), a request for generating a workflow, and optionally a request for generating a schedule of the workflow. Some example prompt templates are provided below.

Create a database for a customer-facing web service vs an internal web service?

Create a workflow to move data from <Database System A> to <Database System B> and run the workflow at <X> time?

Create <Database System A> warehouse named <M>, create a user named <N>, and grant access to warehouse <M> to user <N>?

Create running job named <R> and with configuration <C>?

The prompt generated for input into the LLM may have a modality of text and data around interface interaction. The LLM may be implemented as, e.g., a GPT model or a generative Artificial Intelligence (AI) model that allows code generation and prompt-based code modifications. The LLM may generate a response to a prompt input into the LLM based on execution of the machine-learning model using the prompt. A response to the prompt may include a workflow code and a schedule for a workflow that is defined by the workflow code. The online system 140 may import the response from the model serving system 150 and use the response to create the running pipelines, infrastructure, etc.

In one or more embodiments, the task for the model serving system 150 is based on knowledge of the online system 140 that is fed to the machine-learning model of the model serving system 150, rather than relying on general knowledge encoded in the model weights of the model. Thus, one objective may be to perform various types of queries on the external data in order to perform any task that the machine-learning model of the model serving system 150 could perform. For example, the task may be to perform question-answering, text summarization, text generation, and the like based on information contained in an external dataset.

Thus, in one or more embodiments, the online system 140 is connected to an interface system 160. The interface system 160 receives external data from the online system 140 and builds a structured index over the external data using, for example, another machine-learned language model or heuristics. The interface system 160 receives one or more queries from the online system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses from the model serving system 150 and synthesizes a response to the query on the external data. While the online system 140 can generate a prompt using the external data as context, often times, the amount of information in the external data exceeds prompt size limitations configured by the machine-learning language model. The interface system 160 can resolve prompt size limitations by generating a structured index of the data and offers data connectors to external data sources.

FIG. 1B illustrates an example system environment for an online system 140, in accordance with one or more embodiments. The system environment illustrated in FIG. 1B includes a user client device 100, a picker client device 110, a source computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 is managed by a separate entity from the online system 140. In one or more embodiments, as illustrated in the example system environment in FIG. 1B, the model serving system 150 and/or the interface system 160 is managed and deployed by the entity managing the online system 140. The online system 140 is described in further detail below with regards to FIG. 2.

FIG. 2 illustrates an example system architecture for the online system 140, in accordance with some embodiments. The system architecture illustrated in FIG. 2 includes a data collection module 200, a content presentation module 210, an order management module 220, a machine-learning training module 230, a data store 240, an interface module 250, a prompt generation module 260, and a workflow execution module 270. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user’s name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user’s interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from the source computing system 120, the picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker’s name, the picker’s location, how often the picker has serviced orders for the online system 140, a user rating for the picker, which sources the picker has collected items at, or the picker’s previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker’s interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker’s performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and offers the orders to pickers for service based on picker data. For example, the order management module 220 offers an order to a picker based on the picker’s location and the location of the source from which the ordered items are to be collected. The order management module 220 may also offer an order to a picker based on how many items are in the order, a vehicle operated by the picker, the delivery location, the picker’s preferences on how far to travel to deliver an order, the picker’s ratings by users, or how often a picker agrees to service an order.

In one or more embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker’s current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user’s order.

In one or more embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In one or more embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In one or more embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

With respect to the machine-learning models hosted by the model serving system 150, the machine-learning models may already be trained by a separate entity from the entity responsible for the online system 140. In one or more other embodiments, when the model serving system 150 is included in the online system 140, the machine-learning training module 230 may further train parameters of the machine-learning model based on data specific to the online system 140 stored in the data store 240. As an example, the machine-learning training module 230 may obtain a pre-trained transformer language model and further fine tune the parameters of the transformer language model using training data stored in the data store 240. The machine-learning training module 230 may provide the transformer language model to the model serving system 150 for deployment.

The online system 140 maintains historical information about past workflows, e.g., at the data store 240 or some other module of the online system 140. The interface module 250 may receive a new request for a workflow, e.g., via a user interface of the online system 140. A workflow may represent an operation or a set of operations performed on data stored in the data store 240 and/or in a database of one or more other modules of the online system 140. The request for the workflow may be in a predetermined input form, but without all of the fields being filled. Alternatively, the request for the workflow may be a free text sentence with the user’s intent. The interface module 250 may pass the request for the workflow to the prompt generation module 260.

The prompt generation module 260 may generate a prompt for input into the LLM. In providing the prompt to the LLM, the prompt generation module 260 may provide past workflows that were generated for different purposes including the decisions that were made, usage metrics (e.g., for load balancing), a request for a new workflow, and a request for a schedule of the new workflow. The prompt generation module 260 may include information about the past workflows into the prompt in the form of a vectorized database of past codes (e.g., YAML codes). The prompt generation module 260 may further include a request into the prompt that the LLM generates a schedule for the workload such that the schedule would perform load balancing, e.g., distribution of the load on the warehouse.

The prompt for input into the LLM may be generated based on user’s inputs collected through a user interface of the online system 140 and received at the interface module 250. The user interface may present forms, dropdown menus, or other input mechanisms to capture the user’s desired actions, configurations, and requirements. The prompt generation module 260 may process these inputs algorithmically to generate a structured prompt tailored for the LLM. In one or more embodiments, the prompt generation module 260 applies a processing algorithm that includes parsing the user’s inputs, mapping the parsed inputs to predefined templates or structures, and incorporating any relevant metadata or contextual information required by the LLM. Additionally, the prompt generation module 260 may include in the prompt for input into the LLM various parameters and constraints related to the data processes, resources, and business requirements. The inputs included into the prompt may be gathered through a user interface and/or an input file (e.g., YAML file). In one or more embodiments, the prompt generation module 260 can include a mixture of user interface forms into the prompt.

In one or more embodiments, the prompt generation module 260 generates the prompt algorithmically using one or more input files (e.g., one or more YAML files), a description of the data process (e.g., pipeline, quality check, indexing job, etc.), a database technology, resource specifications (e.g., warehouse profile, compute resources, etc.), user’s preferences (e.g., desired execution frequency, specific time windows for execution, etc.), business constraints (e.g., peak demand periods, cyclical patterns, etc.), historical data (e.g., past execution times, resource utilization patterns, etc.), some other input data, or some combination thereof. The prompt generation module 260 may leverage the algorithmic data points to organize these inputs into a coherent prompt that the LLM can understand and process effectively. In one or more other embodiments, the user can directly communicate with an LLM-based agent using conversation artificial intelligence. In such cases, the user interface input may not be required.

To effectively generate desired workflows and optimized schedules, the LLM may require access to various sources of information within the online system 140. The sources of information may be stored at the data store 240 and/or one or more other modules of the online system 140. The sources of information may include code repositories, documentation data, historical data, resource monitoring data, business data, process metadata, user’s requirements, knowledge bases, some other source of information, or some combination thereof. In one or more embodiments, the prompt generation module 260 (or some other module of the online system 140) can gather some of this information through various methods, such as API integrations, web scraping, or manual curation, which depends on specific data sources and their accessibilities.

The access to the code repositories may allow the LLM to learn from and potentially reuse existing code snippets, templates, best practices, and/or past scheduling patterns. The access to the documentation data may allow the LLM the access to the technical documentation, API references, and other relevant knowledge sources that can be ingested by the LLM to understand the capabilities and usage patterns of the various technologies that are being involved. The access to the resource monitoring data (e.g., monitoring tools or logs stored at the data store 240) may allow the LLM the access to information about resource utilization, such as warehouse usage, compute resource consumption, and query execution times.

The access to the historical data may allow the LLM the access to past workflow definitions, execution logs, and change histories that can provide valuable context and learnings for the LLM to optimize future workflow generations. The historical data may include data related to the warehouse usage, query execution times, and/or resource consumption patterns. The historical data may allow the LLM to understand the existing resource constraints and identify potential bottlenecks or periods of high demand.

The access to the business data, may allow the LLM the access to data related to business cycles (e.g., of the online system 140, or one or more sources associated with the online system 140), peak demand periods during certain hours or days, and other relevant business metrics. The business data may be essential for aligning the schedules with business requirements and ensuring resources are available during critical periods. The prompt generation module 260 may extract the business data from an internal database of the online system 140 and/or data warehouses associated with the online system 140.

The access to the process metadata may allow the LLM the access to details about existing data processes, their dependencies, and historical execution patterns. The process metadata may provide the LLM with insights into potential conflicts, resource contention, and data freshness requirements. The prompt generation module 260 may retrieve the process metadata from a local workflow management database of the workflow execution module 270, job logs (e.g., stored at the data store 240), and/or metadata repositories (e.g., stored at the data store 240).

The access to the user’s requirements may allow the LLM the access to user-specified preferences, constraints related to data process execution, and/or service-level agreements (SLAs) related to data process execution. The user’s requirements may help the LLM generate schedules that meet the desired criteria and prioritize critical processes accordingly. The user’s requirements may be obtained via a user interface of the online system 140 and gathered at, e.g., the interface module 250.

The access to the knowledge bases may allow the LLM the access to technical documentation, best practices, and/or domain knowledge related to database technologies and data processing. The prompt generation module 260 may retrieve data related to the knowledge bases from an internal database of the online system 140, repositories (e.g., stored at the data store), and/or subject matter experts.

An output generated by the LLM may include a workflow code (e.g., YAML code). The workflow code may include a text and a code that can be then deployed to create the running pipelines, infrastructure etc. In one or more embodiments, before the code is being deployed, the interface module 250 may first output the code generated by the LLM to a user interface of the online system 140 for human peer review. After a positive outcome of the human peer review, the workflow execution module 270 may execute the workflow in accordance with the workflow code.

The output generated by the LLM may include a set of recommendations on how to create or tune an infrastructure resource or data pipeline. The output generated by the LLM (e.g., a pipeline, a job, a warehouse, etc.) may be in the form of a code and pull requests, which when merged, can create the resource, and complete the workflow. In one or more embodiments, the output generated by the LLM includes a pull request with a code to create a new pipeline. In one or more other embodiments, the output generated by the LLM includes a pull request with some configuration changes to tune or modify existing pipeline. In one or more other embodiments, the output generated by the LLM includes a set of queries to perform a certain operation. In one or more other embodiments, the output generated by the LLM includes a set of pull requests that can create a library of resources.

In one or more embodiments, the prompt generation module 260 may generate a prompt for input into the LLM with a request to fill in fields in the user’s input form. In such cases, an output generated by the LLM may include the user’s input form with automatically filled-in fields. Then, the workflow execution module 270 (or some other module of the online system 140) may employ the input form with the automatically filled-in fields to generate and run the workflow code.

In one or more other embodiments, the output generated by the LLM includes a schedule for the workload, i.e., the output generated by the LLM is a scheduled output. In such cases, the prompt generation module 260 may generate the prompt for input into the LLM with a request for the LLM to generate a schedule that distributes the load on the warehouse (e.g., achieves load balancing). The scheduled output generated by the LLM may be in the form of text, consisting of the optimized schedules for the specified data processes. The scheduled output may include cron expressions or timestamp strings. The LLM may generate the cron expressions or specific timestamp strings representing the optimized schedule for the main data process and any child processes or dependencies.

The workflow execution module 270 (or some other module of the online system 140) may import from the model serving system 150 the scheduled output generated by the LLM that includes optimized schedules and associated information. The workflow execution module 270 may utilize the scheduled output in different ways. In one or more embodiments, the workflow execution module 270 sends, via the network 130, the scheduled output to one or more entities associated with the online system 140 for manual review and approval. Then, the generated schedules may be presented to subject matter experts or process owners for review and approval. This can allow for additional validation and refinement based on domain-specific knowledge or special considerations.

In one or more other embodiments, the online system 140 automatically deploys the scheduled output generated by the LLM. In such cases, the workflow execution module 270 may employ scheduling tools to deploy the generated schedules (e.g., cron expressions, timestamps, etc.), potentially after a peer review and approval process. This can automate the scheduling process and eliminate manual efforts.

In one or more embodiments, the model serving system 150 retunes the LLM using feedback generated based on what pull requests got merged, suggested changes, and the information mined from, e.g., historical data. By evaluating schedules and monitoring the resource utilization, the feedback for retuning the LLM may be generated.

In summary, the online system 140 prompts the LLM to generate an entire pipeline and a workflow. Then, based on the business requirement, database utilization and database queueing, the online system 140 may run the pipeline at a time when the pipeline is cost efficient and executable without any queueing and/or delays.

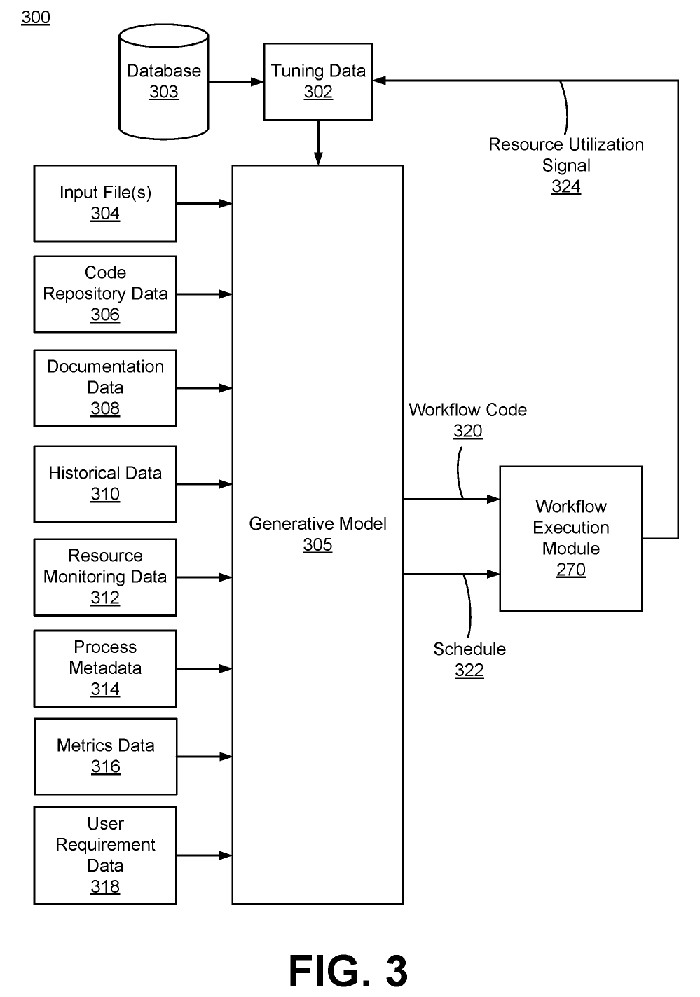

FIG. 3 illustrates an example architectural flow diagram 300 of using a generative model 305 to convert data processes of the online system 140 (e.g., computer system) into workflows, in accordance with one or more embodiments. The generative model 305 may be a language model, such as an LLM (e.g., LLM of the model serving system 150), or may be some other type of transformer-based machine-learning model that is trained to generate a workflow code that runs a workflow. The workflow may represent an operation or a set of operations performed on data stored in the data store 240 and/or in a database of one or more other modules of the online system 140. The generative model 305 may be tuned (e.g., via the model serving system 150) using tuning data 302. The online system 140 may maintain, at a database 303 (e.g., as part of the data store 240), definitions of past workflows executed at the online system 140. The database 303 may be a vectorized database of codes that define the past workflows. The tuning data 302 may be data retrieved from the database 303, e.g., via the model serving system 150.

After tuning the generative model 305, the prompt generation module 260 may generate a prompt for input into the generative model 305. In generating the prompt, the prompt generation module 260 may include into the prompt the one or more input files 304, code repository data 306, documentation data 308, historical data 310, resource monitoring data 312, process metadata 314, metrics data 316, user requirement data 318, some additional data, or some combination thereof. Additionally, the prompt generation module 260 may include into the prompt a request for generating a workflow, as well as another request for generating a schedule of when to execute the workflow.

In providing the one or more input files 304 to the generative model 305, the prompt generation module 260 may provide one or more input forms with some fields filled-in representing the definition of the workflow and some fields that are empty, one or more textual files (or strings) with one or more requirements in relation to the workflow, some other input data, or some combination thereof. The one or more input files 304 may be received from a user of the online system 140, e.g., via a user interface of the online system 140 and gathered at the interface module 250.

In providing the code repository data 306 to the generative model 305, the prompt generation module 260 may provide existing code snippets, code templates, information about past scheduling patterns, some other repository data, or some combination thereof. The prompt generation module 260 may retrieve the code repository data 306 from a code repository database of the online system 140 (e.g., part of the data store 240).

In providing the documentation data 308 to the generative model 305, the prompt generation module 260 may provide technical documentation, API references, information about capabilities of various technologies, resource usage patterns of various technologies, some other documentation data, or some combination thereof. The prompt generation module 260 may retrieve the documentation data 308 from a documentation database of the online system 140 (e.g., part of the data store 240).

In providing the historical data 310 to the generative model 305, the prompt generation module 260 may provide information about past execution times, resource utilization patterns, past workflow definitions, execution logs, data related to a warehouse usage, query execution times, historical resource consumption patterns, some other historical data, or some combination thereof. The prompt generation module 260 may retrieve the historical data 310 from a historical database of the online system 140 (e.g., part of the data store 240).

In providing the resource monitoring data 312 to the generative model 305, the prompt generation module 260 may provide information about resource utilization, warehouse usage data, compute resource consumption data, query execution times, some resource related data, or some combination thereof. The prompt generation module 260 may retrieve the resource monitoring data 312 from a resource monitoring database of the online system 140 (e.g., part of the data store 240).

In providing the process metadata 314 to the generative model 305, the prompt generation module 260 may provide information about existing data processes, information about dependencies of existing data processes, historical execution patterns of data processes, infrastructure data, information about behavior of data pipelines, some other process related data, or some combination thereof. The prompt generation module 260 may retrieve the process metadata 314 from a local workflow management database of the workflow execution module 270, data logs (e.g., stored at the data store 240), and/or metadata repositories (e.g., stored at the data store 240).

In providing the metrics data 316 to the generative model 305, the prompt generation module 260 may provide information about metrics related to utilization of resources of the online system 140 during execution of past workflows, information about business metrics (e.g., peak demand periods during certain hours or days), some other metrics data, or some combination thereof. The prompt generation module 260 may retrieve the metrics data 316 from a workflow database of the online system 140 (e.g., part of the data store 240).

In providing the user requirement data 318 to the generative model 305, the prompt generation module 260 may provide user-specified preferences, user’s defined constraints related to data process execution, information about SLAs related to data process execution, some other user-related requirements, or some combination thereof. The user requirement data 318 may be obtained via the user interface of the online system 140 and gathered at the interface module 250.

Based on the prompt input into the generative model 305, the generative model 305 may generate a first response including a workflow code 320 that defines the workflow and a second response including a schedule 322 of when to execute the workflow. The workflow execution module 270 may import the workflow code 320 and the schedule 322. The workflow execution module 270 may execute the workflow by deploying the workflow code 320. In one or more embodiments, the workflow execution module 270 executes the workflow by executing components of the workflow according to the schedule 322. In such cases, the execution module 270 may distribute a data load across the resources of the online system according to the schedule 322.

In one or more embodiments, the workflow code 320 includes a pull request for creating a new data pipeline at the online system 140. In such cases, by deploying the workflow code 320, the workflow execution module 270 may create the new data pipeline. In one or more other embodiments, the workflow code 320 includes information about one or more configuration changes and a pull request for modifying an existing data pipeline at the online system 140 in accordance with the one or more configuration changes. In such cases, by deploying the workflow code 320, the workflow execution module 270 may modify the existing data pipeline. In one or more other embodiments, the workflow code 320 includes a set of queries to perform an operation at the online system 140. In such cases, by deploying the workflow code 320, the workflow execution module 270 may perform the operation at the online system 140.

During deployment of the workflow code 320, i.e., an execution of the workflow according to the schedule 322, the workflow execution module 270 may monitor a utilization of the resources at the online system 140. The workflow execution module 270 may record information about the utilization of the resources as a resource utilization signal 324. The model serving system 150 may employ the resource utilization signal 324 as part of the tuning data 302 to retune the generative model 305.

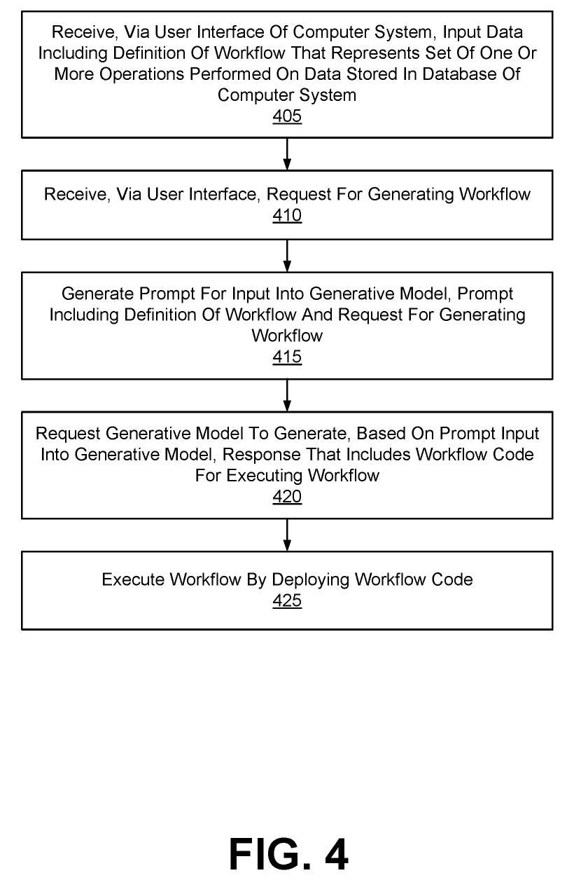

FIG. 4 is a flowchart for a method of using a generative model (e.g., language model) to convert data processes of a computer system (e.g., online system) into workflows, in accordance with one or more embodiments. Alternative embodiments may include more, fewer, or different steps from those illustrated in FIG. 4, and the steps may be performed in a different order from that illustrated in FIG. 4. These steps may be performed by a computer system (e.g., the online system 140). Additionally, each of these steps may be performed automatically by the computer system without human intervention.

The computer system receives 405 (e.g., at the interface module 250), via a user interface of the computer system, input data including a definition of a workflow that represents a set of one or more operations performed on data stored in a database of the computer system (e.g., the data store 240). The computer system receives 410 (e.g., at the interface module 250), via the user interface, a request for generating the workflow.

The computer system may receive the input data by receiving (e.g., at the interface module 250), via the user interface, an input form having a first set of fields representing the definition of the workflow and a second set of fields that are empty. Alternatively, the computer system may receive the input data by receiving (e.g., at the interface module 250), via the user interface, textual data including information about one or more requirements in relation to the workflow

The computer system generates 415 (e.g., via the prompt generation module 260) a prompt for input into a generative model (e.g., LLM of the model serving system 150), the prompt including the definition of the workflow and the request for generating the workflow. The computer system may generate the prompt by further including in the prompt (e.g., via the prompt generation module 260) at least one of: information about a current utilization of resources of the computer system, information about existing data processes at the computer system, or a set of constraints related to an execution of the workflow.

The computer system requests 420 (e.g., via the prompt generation module 260) the generative model to generate, based on the prompt input into the generative model, a response that includes a workflow code for executing the workflow. The computer system executes 425 (e.g., via the workflow execution module 270) the workflow by deploying the workflow code.

In one or more embodiments, the computer system requests (e.g., via the prompt generation module 260) the generative model to generate the response that further includes a pull request for creating a new data pipeline at the computer system using the workflow code. In such cases, the computer system may create (e.g., via the workflow execution module 270) the new data pipeline by deploying the workflow code.

In one or more other embodiments, the computer system requests (e.g., via the prompt generation module 260) the generative model to generate the response that includes the workflow code with information about one or more configuration changes and a pull request for modifying an existing data pipeline at the computer system in accordance with the one or more configuration changes. In such cases, the computer system may modify (e.g., via the workflow execution module 270) the existing data pipeline by deploying the workflow code.

In one or more other embodiments, the computer system requests (e.g., via the prompt generation module 260) the generative model to generate the response that includes the workflow code with a set of queries to perform an operation at the computer system. In such cases, the computer system may perform (e.g., via the workflow execution module 270) the operation by deploying the workflow code.

In one or more embodiments, the computer system further receives (e.g., at the interface module 250), via the user interface, a request for generating a schedule of when to execute the workflow. In such cases, the computer system may generate (e.g., via the prompt generation module 260) a second prompt for input into the generative model, the second prompt including the definition of the workflow, information about resources of the computer system, information about past scheduling patterns, and the request for generating the schedule. The computer system may then request (e.g., via the prompt generation module 260) the generative model to generate, based on the second prompt input into the generative model, a second response that includes the schedule. The computer system may execute the workflow by executing (e.g., via the workflow execution module 270) a plurality of components of the workflow according to the schedule.

The computer system may receive (e.g., at the interface module 250) the request for generating the schedule by receiving a request that a data load is distributed across the resources according to the schedule when executing the workflow. When executing the workflow, the computer system may distribute (e.g., via the workflow execution module 270) the data load across the resources according to the schedule.

In one or more embodiments, the computer system maintains, at a computer-readable medium the computer system (e.g., the data store 240), definitions of past workflows executed at the computer system. The computer system may maintain the definitions of past workflows by maintaining, at the computer-readable medium of the computer system, a vectorized database of codes defining the past workflows. The computer system may tune (e.g., via the model serving system 150) the generative model using the definitions of past workflows.

The computer system may further maintain, at the computer-readable medium of the computer system, information about metrics related to utilization of the resources during execution of past workflows. The model serving system 150 may tune the generative model using the information about metrics. The computer system may monitor (e.g., via the workflow execution module 270) a utilization of the resources when executing the workflow. The computer system may retune (e.g., via the model serving system 150) the generative model using information about the utilization of the resources.

Embodiments of the present disclosure are directed to a computer system (e.g., the online system 140) that uses a generative model (e.g., LLM of the model serving system 150) to convert data processes of the computer system into workflows, where the generative model is tuned with previous workflows. The generative model may generate parameters for a workflow. Alternatively, the generative model may also generate a workflow code. The generative model can also generate a schedule for the workflow, where the generative model is tuned with usage metrics.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
receiving, via a user interface of the computer system, input data including a definition of a workflow that represents a set of one or more operations performed on data stored in a database of the computer system;
receiving, via the user interface, a request for generating the workflow;
generating a prompt for input into a generative model, the prompt including the definition of the workflow and the request for generating the workflow;
requesting the generative model to generate, based on the prompt input into the generative model, a response that includes a workflow code for executing the workflow; and
executing the workflow by deploying the workflow code.

2. The method of claim 1, further comprising:
maintaining, at the computer-readable medium of the computer system, definitions of past workflows executed at the computer system; and
tuning the generative model using the definitions of past workflows.

3. The method of claim 2, wherein maintaining the definitions of past workflows comprises:
maintaining, at the computer-readable medium of the computer system, a vectorized database of codes defining the past workflows.

4. The method of claim 1, further comprising:
receiving, via the user interface, a request for generating a schedule of when to execute the workflow;
generating a second prompt for input into the generative model, the second prompt including the definition of the workflow, information about resources of the computer system, information about past scheduling patterns, and the request for generating the schedule; and
requesting the generative model to generate, based on the second prompt input into the generative model, a second response that includes the schedule,
wherein executing the workflow comprises executing a plurality of components of the workflow according to the schedule.

5. The method of claim 4, wherein:
receiving the request for generating the schedule comprises receiving a request that a data load is distributed across the resources according to the schedule when executing the workflow; and
executing the workflow further comprises distributing the data load across the resources according to the schedule.

6. The method of claim 4, further comprising:
maintaining, at the computer-readable medium of the computer system, information about metrics related to utilization of the resources during execution of past workflows; and
tuning the generative model using the information about metrics.

7. The method of claim 6, further comprising:
monitoring a utilization of the resources when executing the workflow; and
retuning the generative model using information about the utilization of the resources.

8. The method of claim 1, wherein receiving the input data comprises:
receiving, via the user interface, an input form having a first set of fields representing the definition of the workflow and a second set of fields that are empty.

9. The method of claim 1, wherein receiving the input data comprises:
receiving, via the user interface, textual data including information about one or more requirements in relation to the workflow.

10. The method of claim 1, wherein generating the prompt comprises:
generating the prompt by further including in the prompt at least one of information about a current utilization of resources of the computer system, information about existing data processes at the computer system, or a set of constraints related to an execution of the workflow.

11. The method of claim 1, wherein:
requesting the generative model to generate the response further comprises requesting the generative model to generate the response that further includes a pull request for creating a new data pipeline at the computer system using the workflow code; and
executing the workflow comprises creating the new data pipeline by deploying the workflow code.

12. The method of claim 1, wherein:
requesting the generative model to generate the response comprises requesting the generative model to generate the response that includes the workflow code with information about one or more configuration changes and a pull request for modifying an existing data pipeline at the computer system in accordance with the one or more configuration changes; and
executing the workflow comprises modifying the existing data pipeline by deploying the workflow code.

13. The method of claim 1, wherein:
requesting the generative model to generate the response comprises requesting the generative model to generate the response that includes the workflow code with a set of queries to perform an operation at the computer system; and
executing the workflow comprises performing the operation by deploying the workflow code.

14. A computer program product comprising a non-transitory computer readable storage medium having instructions encoded thereon that, when executed by a processor, cause the processor to perform steps comprising:
receiving, via a user interface of a computer system, input data including a definition of a workflow that represents a set of one or more operations performed on data stored in a database of the computer system;
receiving, via the user interface, a request for generating the workflow;
generating a prompt for input into a generative model, the prompt including the definition of the workflow and the request for generating the workflow;
requesting the generative model to generate, based on the prompt input into the generative model, a response that includes a workflow code for executing the workflow; and
executing the workflow by deploying the workflow code.

15. The computer program product of claim 14, wherein the instructions further cause the processor to perform steps comprising:
maintaining, at the computer readable storage medium, definitions of past workflows executed at the computer system as a vectorized database of codes defining the past workflows; and
tuning the generative model using the definitions of past workflows.

16. The computer program product of claim 14, wherein the instructions further cause the processor to perform steps comprising:
receiving, via the user interface, a request for generating a schedule of when to execute the workflow;
generating a second prompt for input into the generative model, the second prompt including the definition of the workflow, information about resources of the computer system, information about past scheduling patterns, and the request for generating the schedule; and
requesting the generative model to generate, based on the second prompt input into the generative model, a second response that includes the schedule,
wherein executing the workflow comprises executing a plurality of components of the workflow according to the schedule.

17. The computer program product of claim 16, wherein the instructions further cause the processor to perform steps comprising:
maintaining, at the computer readable storage medium, information about metrics related to utilization of the resources during execution of past workflows; and
tuning the generative model using the information about metrics.

18. The computer program product of claim 14, wherein the instructions further cause the processor to perform steps comprising:
receiving, via the user interface, the input data including textual data with information about one or more requirements in relation to the workflow.

19. The computer program product of claim 14, wherein the instructions further cause the processor to perform steps comprising:
requesting the generative model to generate the response that further includes a pull request for creating a new data pipeline at the computer system using the workflow code; and
creating the new data pipeline by deploying the workflow code.

20. A computer system comprising:
a processor; and
a non-transitory computer-readable storage medium having instructions that, when executed by the processor, cause the computer system to perform steps comprising:
receiving, via a user interface of the computer system, input data including a definition of a workflow that represents a set of one or more operations performed on data stored in a database of the computer system;
receiving, via the user interface, a request for generating the workflow;
generating a prompt for input into a generative model, the prompt including the definition of the workflow and the request for generating the workflow;
requesting the generative model to generate, based on the prompt input into the generative model, a response that includes a workflow code for executing the workflow; and
executing the workflow by deploying the workflow code.
